(19) United States
(12) Patent Application Publication
(10) Pub. No.: US 2023/0146627 A1
(43) Pub. Date: May 11, 2023

(54) ROBOT CONTROL METHOD AND ROBOT

(71) Applicant: SEIKO EPSON CORPORATION, Tokyo (JP)

(72) Inventor: Ryuichi SATO, MATSUMOTO-SHI (JP)

(21) Appl. No.: 17/979,803

(22) Filed: Nov. 3, 2022

(30) Foreign Application Priority Data
Nov. 5, 2021 (JP) 2021-181064

(51) Int. Cl. B25J 9/16; B25J 13/08

(52) U.S. Cl. CPC B25J 9/1612; B25J 9/1633; B25J 9/1664; B25J 9/1638; B25J 13/088

(57) ABSTRACT

A control method of a robot, the robot including a first member, a second member connected to the first member, a drive device configured to rotate or slide the second member with respect to the first member, and an end effector connected to the second member, wherein posture of the end effector is changed by drive of the drive device, the robot control method includes detecting, based on an output signal from an inertial sensor disposed on the end effector, a gravity influence amount indicating a degree of influence of gravity received by the end effector, determining, based on the detected gravity influence amount, a drive algorithm for the drive device from among a plurality of drive modes, and driving the drive device by the determined drive algorithm.

The present application is based on, and claims priority from JP Application Serial Number 2021-181064, filed Nov. 5, 2021, the disclosure of which is hereby incorporated by reference herein in its entirety.

### BACKGROUND

### 1. Technical Field

The present disclosure relates to a method for controlling a robot and a robot.

### 2. Related Art

For example, JP-A-7-178689 describes a robot having a first arm, a second arm, a piezoelectric actuator for rotating the second arm with respect to the first arm, and an inclination angle sensor disposed at a tip end section of the second arm. In the robot, deflection and torsion of the second arm are measured based on output of the inclination angle sensor, and a drive signal of the piezoelectric actuator is corrected based on the measured value, thereby suppressing a positional shift of the second arm.

In the robot described in JP-A-7-178689, since the inclination angle sensor is disposed on the second arm, the positional shift of the second arm may be suppressed with high accuracy. However, the positional shift of an end effector connected to the tip end section of the second arm cannot be suppressed with high accuracy.

### SUMMARY

A robot control method of the present disclosure, for a robot including a first member, a second member connected to the first member, a drive device configured to rotate or slide the second member with respect to the first member, and an end effector connected to the second member, wherein posture of the end effector is changed by drive of the drive device, the robot control method includes detecting, based on an output signal from an inertial sensor disposed on the end effector, a gravity influence amount indicating a degree of influence of gravity received by the end effector, determining, based on the detected gravity influence amount, a drive algorithm for the drive device from among a plurality of drive modes, and driving the drive device by the determined drive algorithm.

A robot of the present disclosure includes a first member, a second member connected to the first member, a drive device configured to rotate or slide the second member with respect to the first member, an end effector connected to the second member, and a control device that controls drive of the drive device, wherein the control device detects, based on an output signal from an inertial sensor disposed on the end effector, a gravity influence amount indicating a degree of influence of gravity received by the end effector, determines, based on the detected gravity influence amount, a drive algorithm for the drive device from among a plurality of drive modes, and driving the drive device by the determined drive algorithm.

### BRIEF DESCRIPTION OF THE DRAWINGS

FIG. 1 is a diagram showing a robot according to a first embodiment.

FIG. 2 is a diagram showing a piezoelectric drive device.

FIG. 3 is a diagram showing a drive signal of a piezoelectric actuator.

FIG. 4 is a diagram showing vibration state of the piezoelectric actuator.

FIG. 5 is a diagram showing vibration state of the piezoelectric actuator.

FIG. 6 is a block diagram showing configuration of a control device.

FIG. 7 is a view showing a posture which is hardly influenced by gravity.

FIG. 8 is a view showing a posture easily influenced by gravity.

FIG. 9 is a diagram showing a posture easily influenced by gravity.

FIG. 10 is a diagram showing a first drive mode.

FIG. 11 is a diagram showing the first drive mode.

FIG. 12 is a diagram showing the first drive mode.

FIG. 13 is a flowchart showing a method for controlling the robot.

FIG. 14 is a diagram illustrating a drive example in which the gravity influence amount is “low”.

FIG. 15 is a diagram illustrating a drive example in which the gravity influence amount is “medium”.

FIG. 16 is a diagram illustrating a drive example in which the gravity influence amount is “high”.

FIG. 17 is a diagram showing a second drive mode used in a method for controlling a robot according to a second embodiment.

FIG. 18 is a flowchart showing the method for controlling the robot.

FIG. 19 is a diagram showing a robot according to a third embodiment.

### DESCRIPTION OF EMBODIMENT

Hereinafter, a method for controlling a robot and a robot according to the disclosure will be described in detail based on an embodiment illustrated in the accompanying drawings.

### First Embodiment

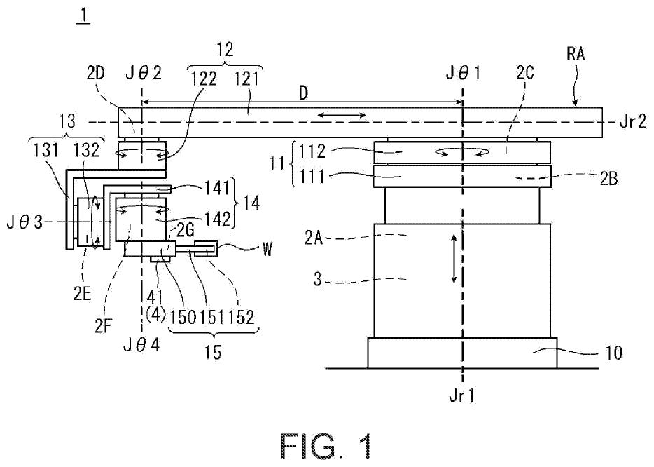

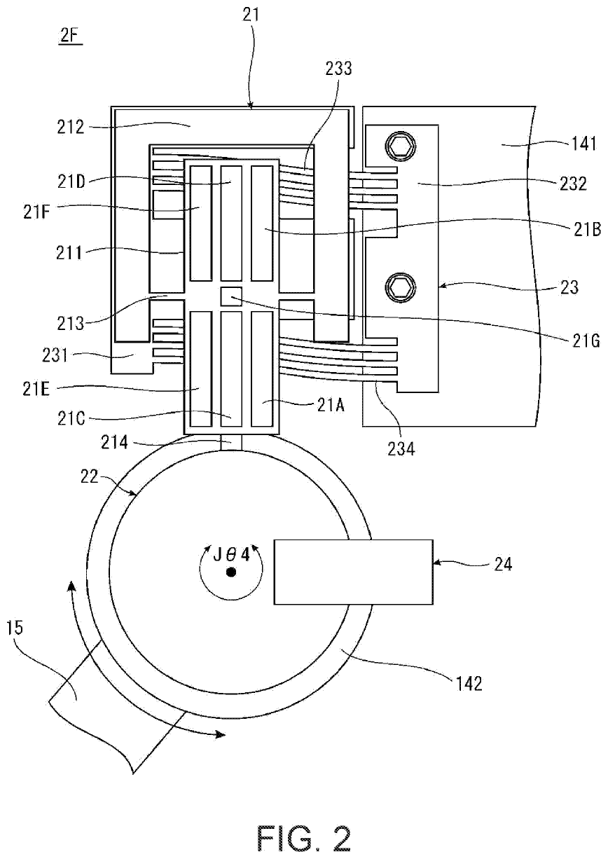

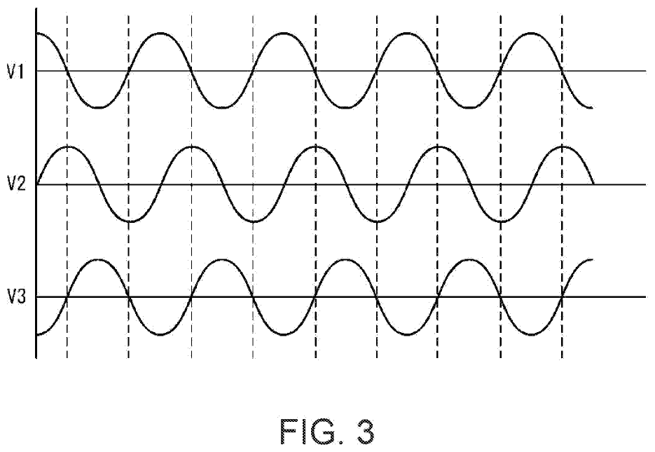

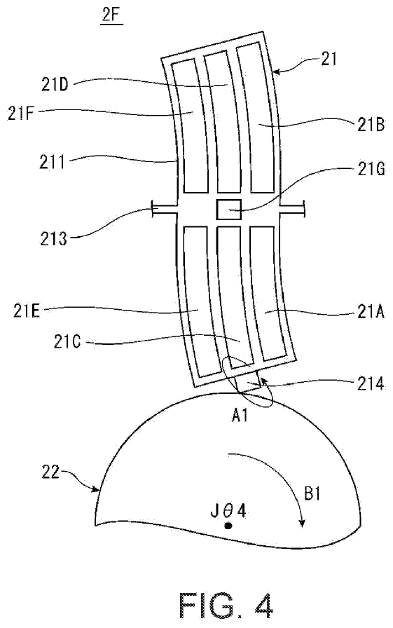

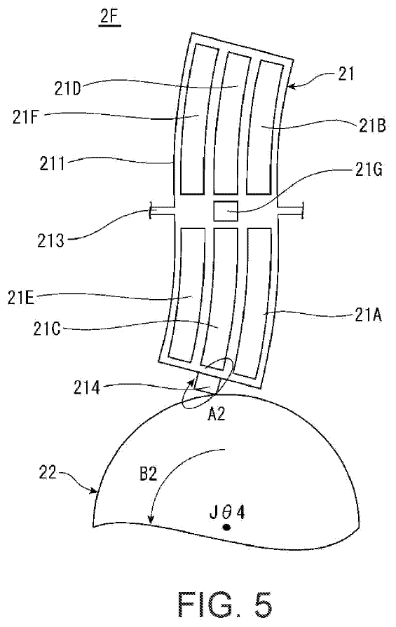

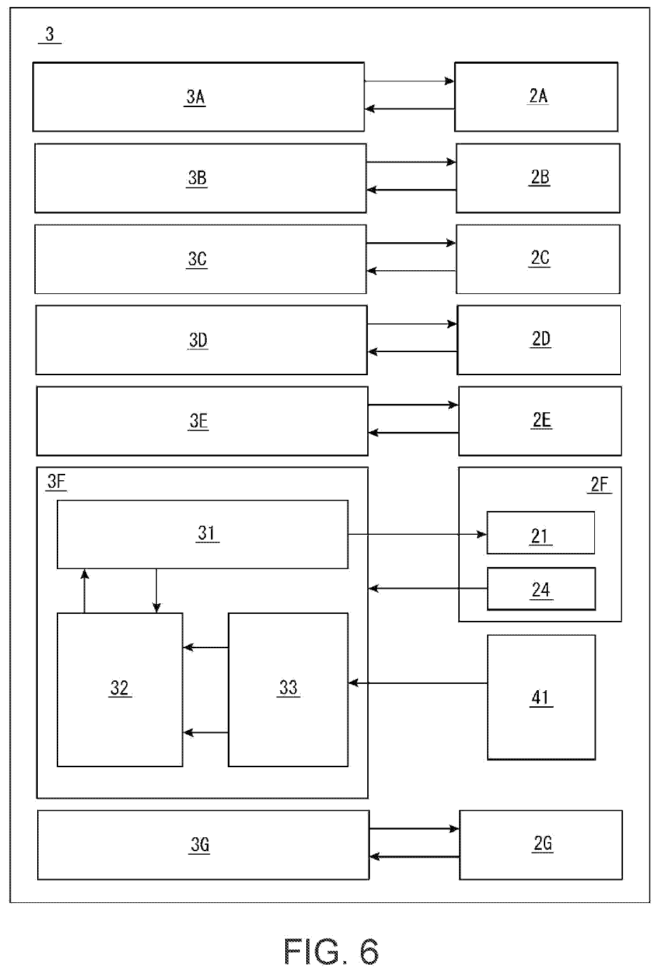

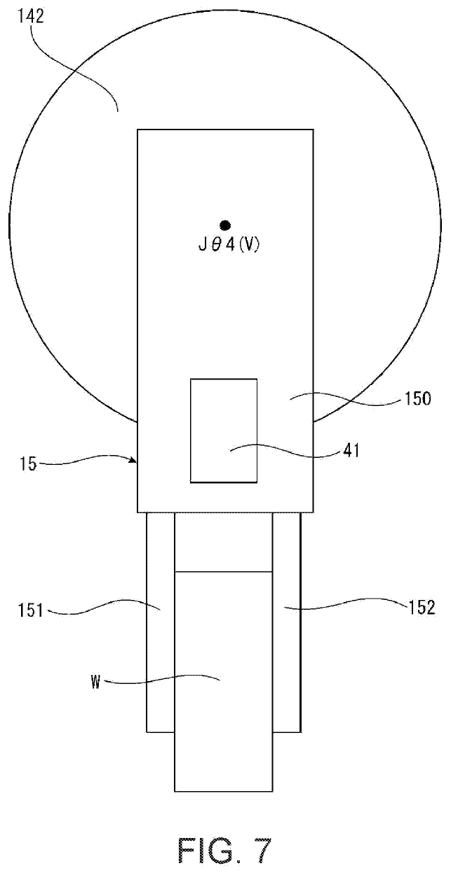

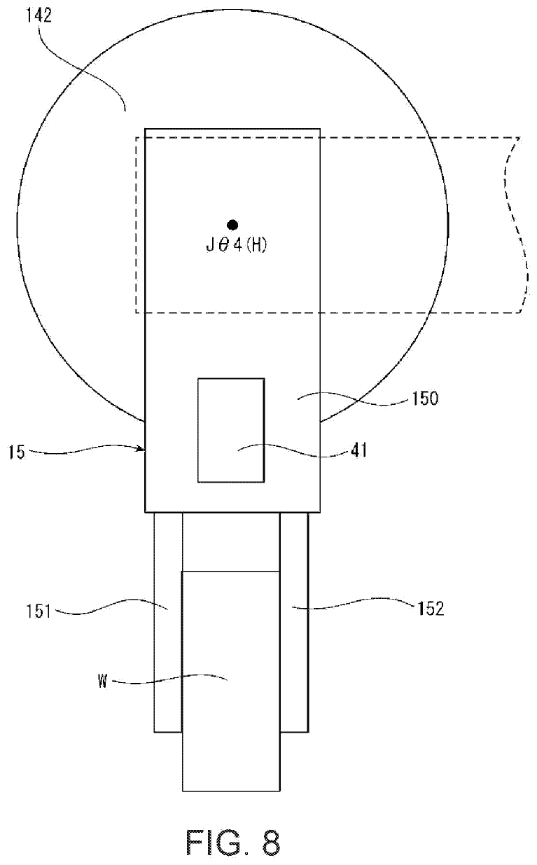

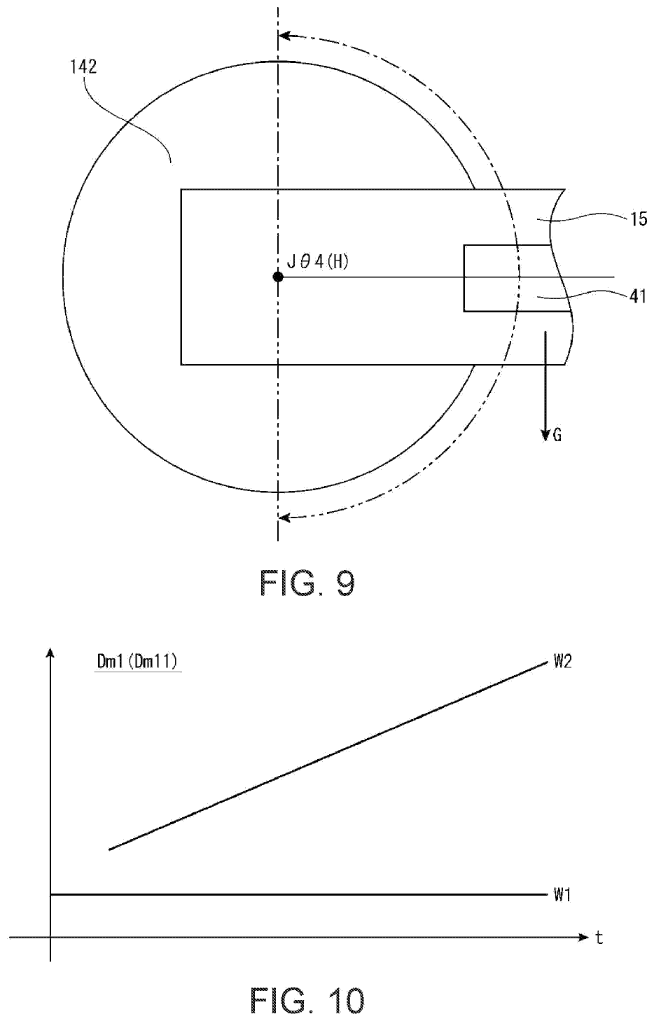

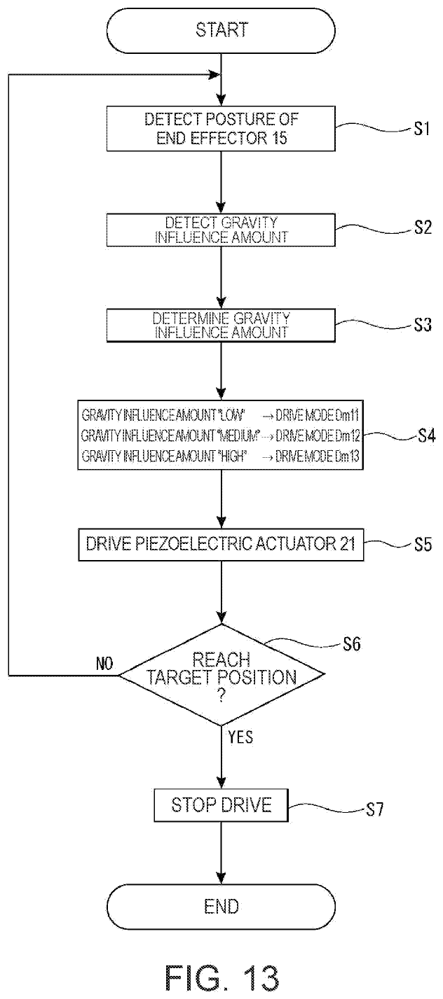

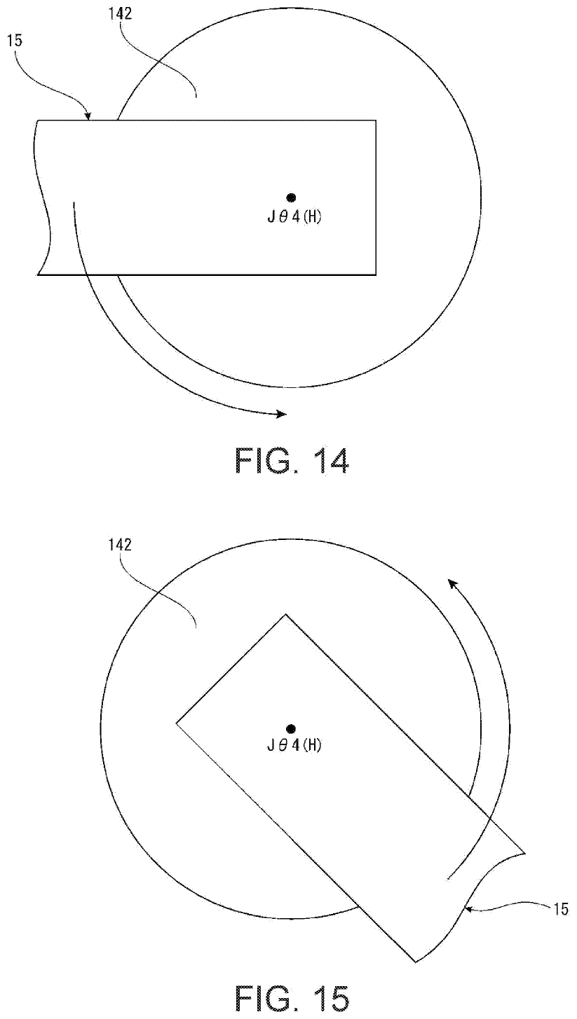

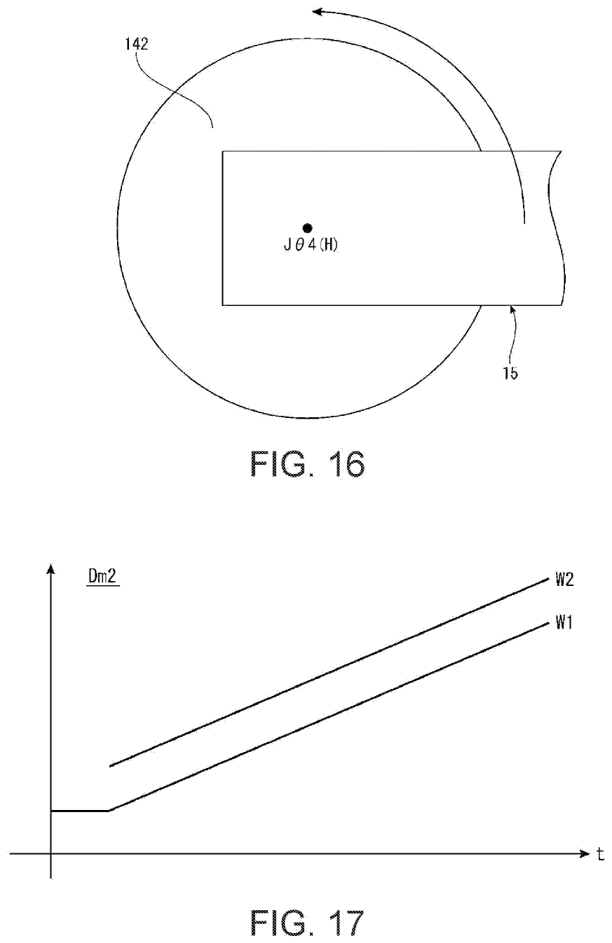

FIG. 1 is a diagram showing a robot according to a first embodiment. FIG. 2 is a diagram showing a piezoelectric drive device. FIG. 3 is a diagram showing a drive signal of a piezoelectric actuator. FIGS. 4 and 5 are diagrams showing vibration state of the piezoelectric actuator. FIG. 6 is a block diagram showing configuration of a control device. FIG. 7 is a view showing a posture which is hardly influenced by gravity. FIGS. 8 and 9 are views each showing posture easily influenced by gravity. FIGS. 10 and 12 are diagrams showing a first drive mode. FIG. 13 is a flowchart showing a method for controlling the robot. FIG. 14 is a diagram illustrating a drive example in which the gravity influence amount is “low”. FIG. 15 is a diagram illustrating a drive example in which the gravity influence amount is “medium”. FIG. 16 is a diagram illustrating a drive example in which the gravity influence amount is “high”.

A robot 1 shown in FIG. 1 is a horizontal articulated robot (scalar robot). The use of the robot 1 is not particularly limited, and examples thereof include feeding, removing, transporting, and assembling of objects such as a precision apparatus or components constituting this.

The robot 1 includes a base 10 fixed to a floor or the like, a robot arm RA connected to the base 10, and an end effector 15 connected to the robot arm RA. The robot arm RA includes a first arm 11 connected to the base 10, a second arm 12 connected to the first arm 11, a third arm 13 connected to the second arm 12, and a fourth arm 14 connected to the third arm 13, and an end effector 15 is connected to the fourth arm 14.

Further, the first arm 11 moves in the direction of a first linear motion axis Jr1 with respect to the base 10, and rotates around a first rotation axis Jθ1, which is parallel to the first linear motion axis Jr1. The second arm 12 moves in a second linear motion axis Jr2 direction orthogonal to the first linear motion axis Jr1 with respect to the first arm 11, and rotates around the second rotation axis Jθ2, which is parallel to the first rotation axis Jθ1. The third arm 13 rotates with respect to the second arm 12 around a third rotation axis Jθ3, which is orthogonal to the second rotation axis Jθ2. The fourth arm 14 rotates with respect to the third arm 13 around a fourth rotation axis Jθ4, which is orthogonal to the third rotation axis Jθ3. The robot 1 sets the end effector 15 in a target position and a target posture by a combination of movements around these four rotation axes Jθ1, Jθ2, Jθ3, and Jθ4 and movements in the two linear motion axes Jr1 and Jr2 directions.

The first arm 11 includes a first linear motion section 111 that is connected to the base 10 and that moves with respect to the base 10 in the direction of the first linear motion axis Jr1, and a first rotation section 112 that is connected to the first linear motion section 111 and that rotates with respect to the first linear motion section 111 around the first rotation axis Jθ1. Note that in the present embodiment, each of the first linear motion axis Jr1 and the first rotation axis Jθ1 extends along the vertical direction. However, the directions of each of these axes Jr1 and Jθ1 are not particularly limited.

The second arm 12 includes an elongated second linear motion section 121 that is connected to the first rotation section 112 and that moves in the second linear motion axis Jr2 direction with respect to the first rotation section 112, and the second rotation section 122 that is connected to a tip end section of the second linear motion section 121 and that rotates around the second rotation axis Jθ2 with respect to the second linear motion section 121. Note that the second linear motion axis Jr2 is orthogonal to the first rotation axis Jθ1 and rotates around the first rotation axis Jθ1 as the first rotation section 112 rotates around the first rotation axis Jθ1. The second rotation axis Jθ2 is parallel to the first rotation axis Jθ1, and a separation distance D between the second rotation axis Jθ2 and the first rotation axis Jθ1 changes as the second linear motion section 121 moves in the direction of the second linear motion axis Jr2.

The third arm 13 includes an arm section 131 connected to the second rotation section 122, and the third rotation section 132 connected to the arm section 131 so as to be rotatable around the third rotation axis Jθ3. The arm section 131 has a substantial L-shape that is bent at a substantially right angle in the middle thereof, the second rotation section 122 is connected to a base end section thereof, and the third rotation section 132 is connected to a tip end section thereof. Note that the third rotation axis Jθ3 is orthogonal to the second rotation axis Jθ2 and rotates around the second rotation axis Jθ2 as the second rotation section 122 rotates around the second rotation axis Jθ2.

The fourth arm 14 includes an arm section 141 as a first member connected to the third rotation section 132, and the fourth rotation section 142 as a second member connected to the arm section 141 so as to be rotatable around the fourth rotation axis Jθ4. The arm section 141 has a substantial L-shape that is bent at a substantially right angle in the middle thereof, the third rotation section 132 is connected to a base end section thereof, and the fourth rotation section 142 is connected to a tip end section thereof. Note that the fourth rotation axis Jθ4 is orthogonal to the third rotation axis Jθ3 and rotates around the third rotation axis Jθ3 as the third rotation section 132 rotates around the third rotation axis Jθ3.

Although the robot arm RA has been described above, the configuration of the robot arm RA is not particularly limited. For example, it may be a six-axis robot arm having six rotation axes.

The end effector 15 is connected to the fourth rotation section 142. The end effector 15 is a mechanism for causing the robot 1 to execute a predetermined work, for example, may have any configuration such as a mechanism for gripping the work W, a mechanism for sucking the work W, and a mechanism for applying an adhesive or the like to the work W. The configuration shown in the drawing includes a base section 150 connected to the fourth rotation section 142 and a pair of claw sections 151, 152 connected to the base section 150, and grips and releases the work W by opening and closing the pair of claw sections 151, 152.

The robot 1 further includes an inertial sensor 4 disposed on the base section 150 of the end effector 15. The robot 1 detects the posture of the end effector 15 based on an output signal of the inertial sensor 4. In the present embodiment, an acceleration sensor 41 is used as the inertial sensor 4. In addition, the acceleration sensor 41 is a three-axis acceleration sensor capable of independently detecting acceleration in each axial direction of an X axis, a Y axis, and a Z axis, which are orthogonal to each other. This makes it possible to accurately detect the posture of the end effector 15. However, the inertial sensor 4 is not particularly limited as long as it can detect the posture of the end effector 15, and may be, for example, an angular velocity sensor.

The robot 1 further includes a piezoelectric drive device 2A that moves the first linear motion section 111 in the first linear motion axis Jr1 direction with respect to the base 10, a piezoelectric drive device 2B that rotates the first rotation section 112 rotates around the first rotation axis Jθ1 with respect to the first linear motion section 111, a piezoelectric drive device 2C that moves the second linear motion section 121 in the second linear motion axis Jr2 with respect to the first rotation section 112, a piezoelectric drive device 2D that rotates the second rotation section 122 rotates around the second rotation axis Jθ2 with respect to the second linear motion section 121, a piezoelectric drive device 2E that rotates the third rotation section 132 rotates around the third rotation axis Jθ3 with respect to the second rotation section 122, a piezoelectric drive device 2F that rotates the fourth rotation section 142 rotates around the fourth rotation axis Jθ4 with respect to the third rotation section 132, a piezoelectric drive device 2G that drives the pair of claw sections 151, 152 to open and close, and a control device 3 that independently controls each of these piezoelectric drive devices 2A to 2G.

From among the piezoelectric drive devices 2A to 2G, the drive of at least the piezoelectric drive device 2F, which controls the drive of the fourth rotation section 142 located at the most tip end side of the robot arm RA, controls the drive by using the following characteristic control method. Therefore, hereinafter, for convenience of description, the piezoelectric drive device 2F will be described as a representative, and description of the other piezoelectric drive devices 2A to 2E, and 2G will be omitted.

As shown in FIG. 2, the piezoelectric drive device 2F as a drive device is a rotary type piezoelectric drive device. The piezoelectric drive device 2F includes a piezoelectric actuator 21, a rotor 22 as a driven body that receives drive force from the piezoelectric actuator 21 and that rotates around the fourth rotation axis Jθ4, a biasing member 23 that presses the piezoelectric actuator 21 against the rotor 22, and an encoder 24 that detects rotation amount of the rotor 22. The piezoelectric actuator 21 is fixed to the arm section 141 via the biasing member 23, and the rotor 22 is fixed to the fourth rotation section 142. Therefore, when the piezoelectric actuator 21 is driven, the fourth rotation section 142 rotates around the fourth rotation axis Jθ4 with respect to the arm section 141. As described above, according to the rotary type piezoelectric drive device, a device suitable for rotationally moving the fourth rotation section 142 is obtained. Note that the piezoelectric actuator 21 may be fixed to the fourth rotation section 142 via the biasing member 23, and the rotor 22 may be fixed to the arm section 141.

According to the piezoelectric drive device 2F, the driving force from the piezoelectric actuator 21 is directly transmitted to the rotor 22. Therefore, a relay mechanism that relays and transmits the driving force is not needed, and the device can be simplified and miniaturized. In addition, a decrease in movement accuracy due to backlash or insufficient rigidity, which is a problem in a relay mechanism such as a decelerator, is substantially eliminated and the robot 1 has excellent drive accuracy. The same rotary type piezoelectric drive device as the piezoelectric drive device 2F is used for the piezoelectric drive devices 2B, 2D, 2E, and 2G, and a linear movement type (linear type) piezoelectric drive device, in which a linear moving slider is used instead of the rotor 22, is used as the piezoelectric drive devices 2A and 2C.

The piezoelectric actuator 21 includes a vibration section 211, a support section 212 that supports the vibration section 211, a beam section 213 that connects the vibration section 211 and the support section 212, and a protrusion-shaped transmission section 214 that is disposed at a tip end section of the vibration section 211 and that transmits vibration of the vibration section 211 to the rotor 22.

The vibration section 211 has a plate-shape, and has a rectangular-shape with the vertical direction of the paper surface in FIG. 2 as a longitudinal side. The vibration section 211 includes piezoelectric elements 21A to 21F for drive and piezoelectric element 21G for detection that detects vibration of the vibration section 211. The piezoelectric elements 21C and 21D are disposed side by side in a longitudinal direction in a central portion of the vibration section 211. The piezoelectric elements 21A and 21B are disposed side by side in the longitudinal direction on one side of the piezoelectric elements 21C and 21D, and the piezoelectric elements 21E and 21F are arranged side by side in the longitudinal direction on the other side. Each of the piezoelectric elements 21A to 21F expands and contracts in the longitudinal direction of the vibration section 211 when energized.

The piezoelectric element 21G for detection is disposed between the piezoelectric elements 21C and 21D. The piezoelectric element 21G receives an external force corresponding to vibration of the vibration section 211 and outputs a detection signal corresponding to the received external force. Therefore, a vibration state of the vibration section 211 can be detected based on the detection signal output from the piezoelectric element 21G.

The transmission section 214 is provided at the tip end section of the vibration section 211, and the tip end thereof is in contact with the rotor 22. Therefore, vibration of the vibration section 211 is transmitted to the rotor 22 through the transmission section 214. The support section 212 is a portion that supports the vibration section 211, and has a U-shape that surrounds both sides and the base end side of the vibration section 211. In addition, the beam section 213 connects the vibration section 211 and the support section 212 in a state in which vibration of the vibration section 211 is allowed.

The biasing member 23 biases the piezoelectric actuator 21 toward the rotor 22 and presses the transmission section 214 against the rotor 22. Accordingly, vibration of the vibration section 211 is efficiently transmitted to the rotor 22 via the transmission section 214. When the piezoelectric drive device 2F is not driven, a brake is applied to the rotor 22, and the posture of the fourth rotation section 142 is maintained. The biasing member 23 includes a holding section 231 that holds the support section 212, a base 232 that is fixed to the arm section 141, and spring groups 233 and 234 that connect the holding section 231 and the base 232. The biasing member 23 is fixed in a state in which the spring groups 233 and 234 are deformed, and presses the piezoelectric actuator 21 against the rotor 22 using a restoring force of the spring groups 233 and 234.

Such a piezoelectric drive device 2F is driven as follows. For example, when a drive signal V1 illustrated in FIG. 3 is applied to the piezoelectric elements 21A and 21F, a drive signal V2 is applied to the piezoelectric elements 21C and 21D, and a drive signal V3 is applied to the piezoelectric elements 21B and 21E, as illustrated in FIG. 4, the vibration section 211 makes a bending vibration that bends in the short side direction while performing a longitudinal vibration that expands and contracts in the longitudinal direction, and these vibrations are combined so that the tip end of the transmission section 214 performs an elliptical motion that draws an elliptical trajectory counterclockwise as indicated by the arrow A1. As a result, the rotor 22 is moved and rotates clockwise as indicated by an arrow B1. On the other hand, when the drive signals V1 and V3 are switched, that is, when the drive signal V1 is applied to the piezoelectric elements 21B and 21E and the drive signal V3 is applied to the piezoelectric elements 21A and 21F, as shown in FIG. 5, the tip end of the transmission section 214 performs an elliptical motion that draws an elliptical trajectory clockwise as indicated by the arrow A2, and the rotor 22 rotates counterclockwise as indicated by an arrow B2.

Note that, from among the longitudinal vibration and the bending vibration of the vibration section 211, which are the basis of the elliptical motion of the transmission section 214, the longitudinal vibration is excited by applying of the drive signal V2 to the piezoelectric elements 21C and 21D, and the bending vibration is excited by applying of the drive signals V1 and V3 to the piezoelectric elements 21A, 21B, 21E, and 21F.

The control device 3 is constituted by, for example, a computer, and includes a processor that processes information, a memory that is communicably connected to the processor, and an external interface. In addition, the memory stores a program executable by the processor, and the processor reads and executes the program stored in the memory. Such a control device 3 receives a command from a host computer (not shown) and independently controls the drive of each of the piezoelectric drive devices 2A to 2G so that the end effector 15 becomes the target position and the target posture based on the command.

As shown in FIG. 6, the control device 3 includes control sections 3A, 3B, 3C, 3D, 3E, 3F, and 3G that control the piezoelectric drive devices 2A, 2B, 2C, 2D, 2E, 2F, and 2G, and in particular, the control section 3F, which controls drive of the piezoelectric drive device 2F, includes a drive signal generation section 31, a drive algorithm selection section 32, and a posture detection section 33 that detects posture or the like of the end effector 15. The posture detection section 33 detects the posture of the end effector 15 based on the output signal of the acceleration sensor 41. In addition, the posture detection section 33 detects, based on at least the detected posture, a degree of influence (hereinafter, a gravity influence amount) of gravity G received by the piezoelectric drive device 2F. Note that, in this embodiment, in addition to the detected posture, the gravity influence amount is detected in consideration of the weight of the end effector 15 and the work W gripped by the end effector 15. Accordingly, it is possible to detect a more accurate gravity influence amount. Note that a method of detecting the gravity influence amount is not particularly limited as long as the method is based on an output signal of the acceleration sensor 41.

The drive algorithm selection section 32 selects a drive algorithm of the piezoelectric actuator 21 based on the detection result of the posture detection section 33, that is, the posture and the gravity influence amount of the end effector 15, and on the target position of the end effector 15. The drive algorithm is selected from a first drive mode Dm1 and a second drive mode Dm2, as described below. The drive signal generation section 31 generates the drive signals V1, V2, and V3 based on the drive algorithm selected by the drive algorithm selection section 32 and a command from the host computer (not shown), and applies the generated drive signals V1, V2, and V3 to the piezoelectric actuator 21. According to such the method, since the actual rotation amount and rotation direction detected by the encoder 24 are fed back, the movement of the end effector 15 can be accurately controlled.

The configuration of the robot 1 has been briefly described above. Next, a method of controlling the piezoelectric drive device 2F will be described. In the control method of the piezoelectric drive device 2F, an optimal drive algorithm is selected based on the posture and the gravity influence amount of the end effector 15 and on the target position of the end effector 15, and drive of the piezoelectric drive device 2F is controlled by using the selected drive algorithm. Accordingly, it is possible to reduce an influence of gravity G on the piezoelectric drive device 2F as much as possible and to accurately control the minute movement of the robot 1.

Before describing the control method, a case where the piezoelectric drive device 2F is not likely to be influenced by gravity G and a case where the piezoelectric drive device 2F is easily influenced by gravity G will be briefly described. FIG. 7 shows an example which is hardly influenced by gravity G, and FIG. 8 shows an example which is easily influenced by gravity G.

In FIG. 7, the fourth rotation axis Jθ4 is along the vertical direction V. In this case, in the operation of rotating the end effector 15 around the fourth rotation axis Jθ4, the gravity influence amount received by the piezoelectric drive device 2F is constant regardless of the current position and the target position of the end effector 15. On the other hand, in FIG. 8, the fourth rotation axis Jθ4 is along the horizontal direction H. In this case, the gravity influence amount received by the piezoelectric drive device 2F varies depending on the posture of the end effector 15, for example, when the end effector 15 is oriented in the vertical direction as indicated by solid line, the gravity influence amount is smallest, and when the end effector 15 is oriented in the horizontal direction as indicated by chain line, the gravity influence amount is largest.

In addition, in the example of FIG. 8, the gravity influence amount received by the piezoelectric drive device 2F also varies depending on the rotation direction of the end effector 15. For example, as shown by one dot chain line in FIG. 9, when it is desired to rotate the end effector 15 upward (counterclockwise) by 90° from the current position, gravity G resists the driving force of the piezoelectric drive device 2F, and conversely, when it is desired to rotate the end effector 15 downward (clockwise) by 90° from the current position, gravity G is added to the driving force of the piezoelectric drive device 2F. As described above, in the example of FIG. 8, the gravity influence amount varies depending on the current position or the target position of the end effector 15, and accordingly, the drive of the piezoelectric drive device 2F is likely to become unstable. Therefore, it becomes difficult to accurately perform the minute movement control of the end effector 15.

As described above, there is a concern that the position accuracy of the end effector 15 may decrease due to the gravity influence amount. Therefore, as described above, in the present embodiment, an optimal drive algorithm is selected based on the posture and the gravity influence amount of the end effector 15 and on the target position of the end effector 15, and the drive of the piezoelectric drive device 2F is controlled by using the selected drive algorithm.

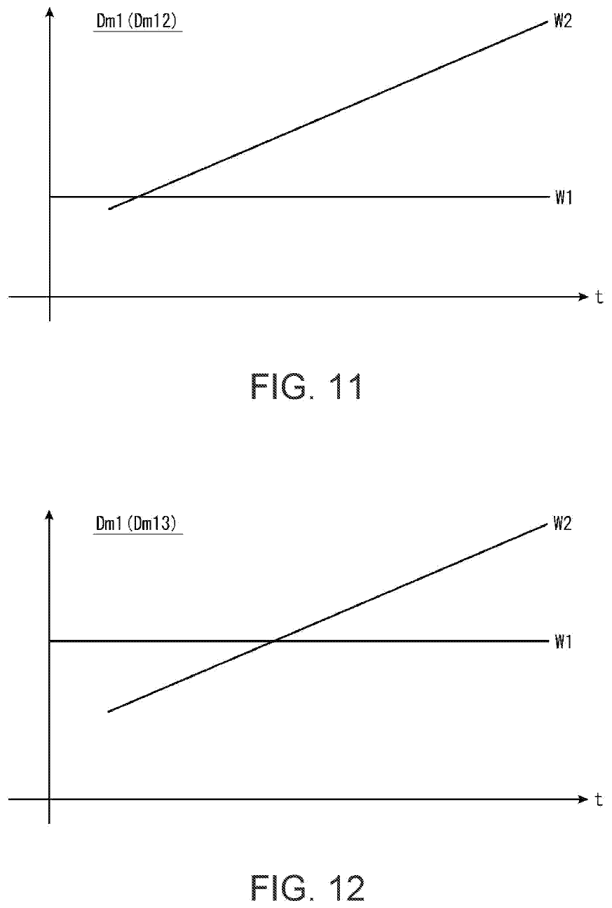

Next, the drive algorithm previously set for the robot 1 will be described. In the present embodiment, as the drive algorithm, as shown in FIGS. 10 to 12, a first drive mode Dm1 is set to increase separation amplitude W2, which is the amplitude of the longitudinal vibration, while keeping feed amplitude W1, which is the amplitude of the bending vibration, constant. Further, a plurality of modes Dm11, Dm12, and Dm13, each having a different feed amplitude W1, is set as the first drive mode Dm1. That is, in the present embodiment, three drive modes are set as the drive algorithm.

According to the first drive mode Dm1, it is easy to generate a minimum necessary drive force. Therefore, a sudden large movement of the rotor 22, due to an excessive driving force, is unlikely to occur and the stopping accuracy is also good. On the other hand, since the driving force increases little by little in order to generate the minimum necessary driving force, the driving force is easily influenced by gravity G at the initial stage of the drive start. Therefore, in the present embodiment, by selecting a drive mode having a driving force that is optimal with respect to a degree of the influence of gravity G, that is, that can realize an appropriate amount of movement without yielding over to gravity G, a drive method that is less likely to be influenced by gravity G and is excellent in stopping accuracy is provided.

However, the drive mode set as the drive algorithm is not particularly limited, and it is sufficient that least two different drive modes are set.

In this embodiment, the feed amplitude W1 is controlled by the voltage values of the drive signals V1 and V3, and the separation amplitude W2 is controlled by the voltage value of the drive signal V2. This facilitates control of the amplitude W1 and W2. However, a method of controlling the amplitudes W1 and W2 is not limited thereto, and, for example, it may be controlled by the frequency or phase of the drive signals V1, V2, and V3. Further, as will be understood from the following description, “making the feed amplitude W1 constant” means a state in which the voltage values of the drive signals V1, V3 for controlling the bending vibration are made constant, and the actual amplitudes are not necessarily constant. Further, the above mentioned term “constant” includes the meaning of, for example, when a minute change, which may occur due to the configuration of the circuit, occurs, in addition to when there is no change with time.

In addition, as illustrated in FIGS. 10 to 12, in the first drive mode Dm1, the longitudinal vibration is excited after the bending vibration is excited in the piezoelectric actuator 21. As a result, the first drive mode Dm1 is less influenced by gravity G. Specifically, in a state in which the bending vibration is excited in the piezoelectric actuator 21, the transmission section 214 is kept in a state pressed against the rotor 22 by the biasing member 23. Therefore, bending deformation of the vibration section 211 is not allowed, and the bending vibration does not actually occur in the vibration section 211. For example, in the case of a vehicle, this state corresponds to a state of strongly stepping on the brake while stepping on the accelerator, so as not to start movement of the vehicle. In this state, when the longitudinal vibration is excited in the piezoelectric actuator 21, the transmission section 214 is separated from the rotor 22 by the longitudinal vibration, and at the same time, the suppressed the bending vibration is released and generates an elliptical motion of the transmission section 214. That is, since the time lag from the separation of the transmission section 214 from the rotor 22 to the generation of the driving force is very short (substantially 0), the rotor 22 does not become free and is less likely to be influenced by gravity G.

On the other hand, when the bending vibration is excited after the longitudinal vibration is excited, the transmission section 214 is separated from the rotor 22 before the force for sending out the rotor 22 is generated. For example, in the case of a vehicle, this state corresponds to a state in which the brake is released without stepping on the accelerator, that is, a neutral state. Therefore, there is a concern that the rotor 22 becomes free and unintentionally moves due to the influence of gravity G, and the accuracy of the minute movement of the end effector 15 decreases.

The method of controlling the piezoelectric drive device 2F will be described below with reference to FIG. 13, but this control is executed by the control section 3F of the control device 3. In the method of controlling the piezoelectric drive device 2F, first, as step S1, the posture of the end effector 15 is detected based on the output signal of the acceleration sensor 41. Next, as step S2, the gravity influence amount is detected based on the posture or the like detected in the step S1. Note that in the present embodiment, since three drive modes Dm11, Dm12, and Dm13 are set as the drive algorithm, the gravity influence amount is classified into three levels of “low”, “medium”, and “high” in accordance with thereof.

Next, as step S3, it is determined whether the gravity influence amount detected in step S2 is classified into “low”, “medium”, or “high”. Next, as step S4, one of the drive modes Dm11, Dm12, and Dm13 is selected based on the classification of the gravity influence amount determined in step S3 and on the rotation direction (clockwise/counterclockwise) of the end effector 15, and is set as the drive algorithm. For example, when the gravity influence amount is “low”, such as when the end effector 15 is to be rotated counterclockwise from the 9 o'clock position as shown in FIG. 14, the drive mode Dm11 with the smallest driving force is selected, when the gravity influence amount is “medium”, such as when the end effector 15 is to be rotated counterclockwise from the half past 4 o'clock position as shown in FIG. 15, the drive mode Dm12 with the middle driving force is selected, and when the gravity influence amount is “high”, such as when the end effector 15 is to be rotated around the counterclockwise from the 3 o'clock position as shown in FIG. 16, the drive mode Dm13 with the largest driving force is selected.

Next, as step S5, the piezoelectric actuator 21 are driven by the set drive algorithm, and the end effector 15 is moved toward the target position. Next, as step S6, it is determined whether the end effector 15 has reached the target position. If the determination result is “not reached”, the process returns to step S1, and steps S1 to S6 are repeated until the determination result is “reached”. Accordingly, since it is possible to switch the drive mode in real time based on the posture of the end effector 15 and the gravity influence amount which changes from moment to moment, excellent minute movement accuracy is possible. When the determination result is “reached”, as step S7, the drive of the piezoelectric drive device 2F is stopped. As a result, the movement of the end effector 15 to the target position ends normally. According to such a control method, it becomes less likely to be influenced by gravity G, and it is possible to effectively suppress positional shift of the end effector 15.

The robot 1 and the robot control method 1 according to the present embodiment have been described above. As described above, in the control method for the robot 1 that includes the arm section 141 as the first member, the fourth rotation section 142 as the second member connected to the arm section 141, the piezoelectric drive device 2F as the drive device configured to rotate or slide the fourth rotation section 142 with respect to the arm section 141, and the end effector 15 connected to the fourth rotation section 142, wherein the posture of the end effector 15 is changed by drive the piezoelectric drive device 2F, the robot control method 1 includes detecting, based on the output signal from the inertial sensor 4 disposed on the end effector 15, the gravity influence amount indicating the degree of the influence of gravity G on the end effector 15, determining, based on the detected gravity influence amount, the drive algorithm for the piezoelectric drive device 2F from among the plurality of drive modes Dm11, Dm12, and Dm13, and driving the piezoelectric drive device 2F by the determined drive algorithm. This makes drive of the piezoelectric drive device 2F less likely to be influenced by gravity G, and it is possible to effectively suppress the positional shift of the end effector 15.

Further, as described above, the drive algorithm is determined based on the gravity influence amount and moving direction of the end effector 15 to the target position. This makes it possible to determine a more optimal drive algorithm.

As described above, the piezoelectric drive device 2F rotates the fourth rotation section 142 around the fourth rotation axis Jθ4 as the rotation axis, and, in a plan view along the fourth rotation axis Jθ4, a centroid of the end effector 15 is separated from the fourth rotation axis Jθ4. Accordingly, the drive of the piezoelectric drive device 2F becomes likely to be influenced by gravity G, and the effect of the control method described above is more remarkably exhibited.

As described above, the drive device includes the vibration section 211 disposed on one of the arm section 141 and the fourth rotation section 142 and including the piezoelectric elements 21A to 21F, the rotor 22 as a driven body disposed on the other of the arm section 141 and the fourth rotation section 142, and the transmission section 214 configured to transmit vibration of the vibration section 211 to the rotor 22 and the drive device is the piezoelectric drive device 2F that, by energization to the piezoelectric elements 21A to 21F, vibrates the vibration section 211 in a combination of longitudinal vibration and bending vibration to cause the transmission section 214 to perform the elliptical motion, and to move the rotor 22 by the elliptical motion. According to the piezoelectric drive device 2F, the driving force from the piezoelectric actuator 21 is directly transmitted to the rotor 22. Therefore, a relay mechanism that relays and transmits the driving force is not needed, and the device can be simplified and miniaturized. In addition, a decrease in movement accuracy due to backlash or insufficient rigidity, which is a problem in a relay mechanism such as a decelerator, is substantially eliminated and the robot 1 has excellent drive accuracy.

Further, as described above, the drive mode includes a first drive mode Dm1 in which the separation amplitude W2, which is the amplitude of the longitudinal vibration, is increased while the feed amplitude W1, which is the amplitude of the bending vibration, is kept constant and a plurality of different feed amplitudes W1 are set in the first drive mode Dm1. According to such the first drive mode Dm1, the minute movement control of the fourth rotation section 142 becomes easy.

Further, as described above, in the first drive mode Dm1, the bending vibration is excited and then the longitudinal vibration is excited. Accordingly, the influence of gravity G can be further reduced, and the positional shift of the end effector 15 can be more effectively suppressed.

As described above, the robot 1 includes the arm section 141 as a first member, the fourth rotation section 142 as a second member connected to the arm section 141, the piezoelectric drive device 2F as a drive device configured to rotate or slide the fourth rotation section 142 with respect to the arm section 141, the end effector 15 connected to the fourth rotation section 142, and the control device 3 that controls drive of the piezoelectric drive device 2F. Also, the control device 3 detects, based on the output signal from the inertial sensor 4 disposed on the end effector 15, the gravity influence amount indicating the degree of the influence of gravity G received by the end effector 15, determines, based on the detected gravity influence amount, the drive algorithm for the piezoelectric drive device 2F from among a plurality of drive modes Dm11, Dm12, and Dm13, and drives the piezoelectric drive device 2F the determined drive algorithm. This makes drive of the piezoelectric drive device 2F less likely to be influenced by gravity G, and it is possible to effectively suppress the positional shift of the end effector 15.

### Second Embodiment

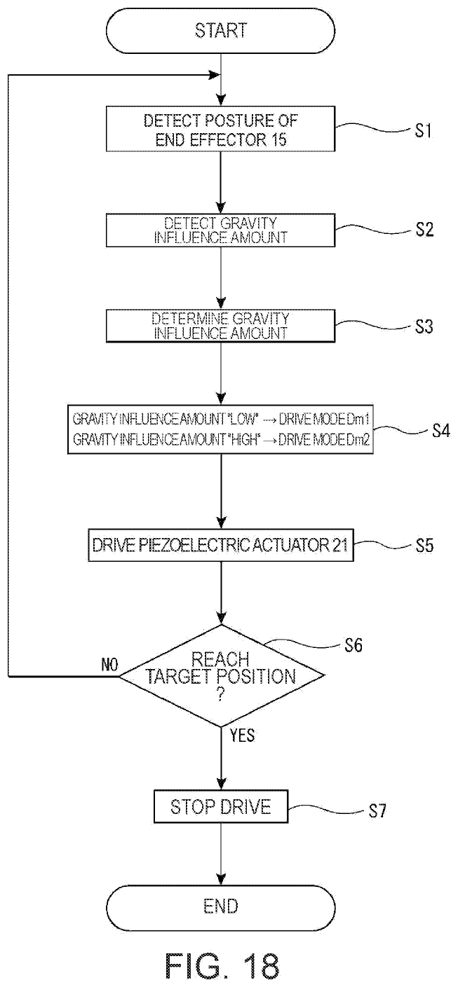

FIG. 17 is a diagram showing the second drive mode used in a method for controlling a robot according to a second embodiment. FIG. 18 is a flowchart showing the method for controlling the robot.

The robot 1 of the present embodiment is the same as the robot 1 of the first embodiment described above except that the drive mode included in the drive algorithm is different. Therefore, in the following description, the present embodiment will be described with a focus on differences from the first embodiment described above, and the description of similar matters will be omitted. In the drawings of the present embodiment, the same components as those of the above described embodiment are denoted by the same reference numerals.

In the present embodiment, as the drive algorithm, two modes are set, the first drive mode Dm1 illustrated in FIG. 10 of the first embodiment described above, and a second drive mode Dm2 in which the feed amplitude W1 is increased while the separation amplitude W2 is increased as illustrated in FIG. 17.

In the first drive mode Dm1, the feed amplitude W1 is kept constant and only the separation amplitude W2 is gradually increased. Therefore, it is easy to generate the minimum necessary driving force. Therefore, a sudden large movement of the rotor 22, due to an excessive driving force, is unlikely to occur and the stopping accuracy is also good. On the other hand, since the driving force is increased little by little in order to generate the minimum necessary driving force, the driving force is easily influenced by gravity G at the initial stage of starting the driving at the initial stage of the drive start. In contrast, in the second drive mode Dm2, both the feed amplitude W1 and the separation amplitude W2 are gradually increased. For this reason, although it is easily influenced by gravity G immediately after drive, since the degree of increase in the driving force is higher than that in the first drive mode Dm1, afterward it is less susceptible to the influence of gravity G than is the first drive mode Dm1. On the other hand, since the pace of increase of the feed amplitude W1 is faster than that of the first drive mode Dm1, the stopping accuracy may be reduced due to excessive driving force depending on the rotational speed of the rotor 22 or the like. In this manner, the first drive mode Dm1 and the second drive mode Dm2, which have opposite characteristics, are switched in accordance with the gravity influence amount, so that the influence of gravity G is less likely to occur.

Hereinafter, the method of controlling the piezoelectric drive device 2F will be described with reference to FIG. 18. In the method of controlling the piezoelectric drive device 2F, first, as step S1, the posture of the end effector 15 is detected based on the output signal of the acceleration sensor 41. Next, as step S2, the gravity influence amount is detected based on the posture or the like detected in the step S1. Note that in this embodiment, since two drive modes Dm1 and Dm2 are set as the drive algorithm, the gravity influence amount is classified into two stages of “low” and “high” accordingly.

Next, as step S3, it is determined whether the gravity influence amount detected in step S2 is classified into “low” or “high”. Next, as step S4, one of the first drive mode Dm1 and the second drive mode Dm2 is selected based on the classification of the gravity influence amount determined in step S3 and the rotation direction (clockwise/counterclockwise) of the end effector 15, and is set as the drive algorithm. Specifically, when the gravity influence amount is “low”, the first drive mode Dm1 with small driving force and high minute movement accuracy is selected, and when the gravity influence amount is “high”, the second drive mode Dm2 with large driving force is selected.

Next, as step S5, the piezoelectric actuator 21 are driven by the set drive algorithm, and the end effector 15 is moved toward the target position. Next, as step S6, it is determined whether the end effector 15 has reached the target position. If the determination result is “not reached”, the process returns to step S1, and steps S1 to S6 are repeated until the determination result is “reached”. Accordingly, since it is possible to switch the drive mode in real time based on the posture of the end effector 15 and the gravity influence amount which changes from moment to moment, excellent minute movement accuracy is possible. When the determination result is “reached”, as step S7, the drive of the piezoelectric drive device 2F is stopped. As a result, the movement of the end effector 15 to the target position ends normally. According to such a control method, it becomes less likely to be influenced by gravity G, and it is possible to effectively suppress positional shift of the end effector 15.

As described above, the robot control method 1 according to the present embodiment has, as the drive mode, the first drive mode Dm1 that increases the separation amplitude W2, which is the amplitude of the longitudinal vibration, while keeping the feed amplitude W1, which is the amplitude of the bending vibration, constant and the second drive mode Dm2 that increases both the feed amplitude W1 and the separation amplitude W2. In the first drive mode Dm1, it is easy to generate the minimum necessary drive force, but the drive force is increased little by little, so that the first drive mode SL is easily influenced by gravity G at the initial stage of the driving start. In contrast to this, the second drive mode Dm2 is hardly influenced by gravity G, but the stopping accuracy may be reduced due to excessive driving force. In this manner, by setting the first drive mode Dm1, which is easily influenced by gravity G but has high fine movement accuracy, and the second drive mode Dm2, which is hardly influenced by gravity G but has inferior fine movement accuracy, it is possible to more suitably perform selection of the drive mode according to the gravity influence amount. Therefore, it is possible to effectively suppress the positional shift of the end effector 15.

According to the second embodiment as described above, the same effects as those of the first embodiment described above can be exhibited.

### Third Embodiment

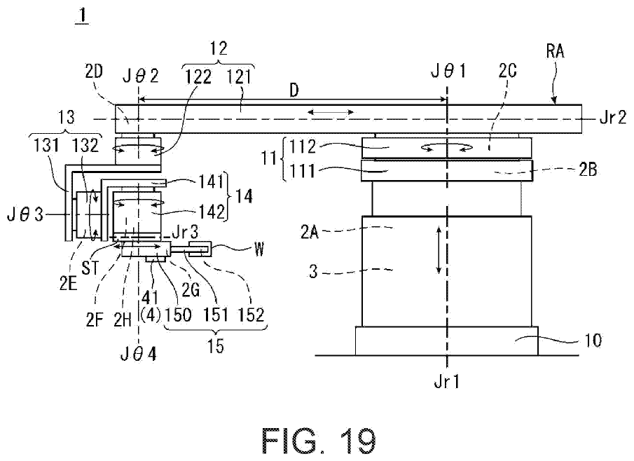

FIG. 19 is a diagram showing a robot according to a third embodiment.

The robot 1 of the present embodiment is the same as the robot 1 of the first embodiment described above except that the configuration of the robot arm RA is different. Therefore, in the following description, the present embodiment will be described with a focus on differences from the first embodiment described above, and the description of similar matters will be omitted. In the drawings of the present embodiment, the same components as those of the above described embodiment are denoted by the same reference numerals.

In addition to the first embodiment, in this embodiment, the robot arm RA further includes a stage ST as the second member connected to the fourth rotation section 142 as the first member, and a piezoelectric drive device 2H as a drive device for moving the stage ST with respect to the fourth rotation section 142 in the direction of the third linear motion axis Jr3, which is orthogonal to the fourth rotation axis Jθ4. The end effector 15 is disposed on the stage ST. In this case, the piezoelectric drive device 2H is not influenced by gravity G when the third linear motion axis Jr3 is horizontally oriented, but is influenced by gravity G when the third linear motion axis Jr3 is inclined with respect to the horizontal direction, particularly when the third linear motion axis Jr3 is vertically oriented. Therefore, by applying the control method of the piezoelectric drive device 2F described in the above described embodiments to the control of the piezoelectric drive device 2H in the present embodiment, the drive of the piezoelectric drive device 2H is hardly influenced by gravity G, and the positional shift of the end effector 15 by gravity G can be effectively suppressed.

According to the third embodiment as described above, the same effects as those of the first embodiment can be achieved.

Although the robot control method and the robot according to the disclosure have been described above based on the illustrated embodiments, the disclosure is not limited thereto, and the configuration of each part can be replaced with an arbitrary configuration having the same function. In addition, other arbitrary components may be added to the present disclosure.

In addition, in the above described embodiments, the configuration in which the piezoelectric drive device is used as the drive device has been described, but the disclosure is not limited thereto, and a drive device other than the piezoelectric drive device, for example, a drive device in which an electromagnetic motor and a decelerator are combined may be used.

What is claimed is:

1. A robot control method, for a robot including:
a first member;
a second member connected to the first member;
a drive device configured to rotate or slide the second member with respect to the first member; and
an end effector connected to the second member, wherein
posture of the end effector is changed by drive of the drive device, the robot control method comprising:
detecting, based on an output signal from an inertial sensor disposed on the end effector, a gravity influence amount indicating a degree of influence of gravity received by the end effector;
determining, based on the detected gravity influence amount, a drive algorithm for the drive device from among a plurality of drive modes; and
driving the drive device by the determined drive algorithm.

2. The robot control method according to claim 1, wherein
the drive algorithm is determined based on the gravity influence amount and on a moving direction of the end effector to a target position.

3. The robot control method according to claim 1, wherein
the drive device rotates the second member around a rotation axis and
in a plan view along the rotation axis, a centroid of the end effector is separated from the rotation axis.

4. The robot control method according to claim 1, wherein
the drive device includes a vibration section disposed on one of the first member and the second member and including a piezoelectric element, a driven body disposed on the other of the first member and the second member, and a transmission section configured to transmit vibration of the vibration section to the driven body and
the drive device is a piezoelectric drive device that, by energization of the piezoelectric element, vibrates the vibration section in a combination of longitudinal vibration and bending vibration to cause the transmission section to perform elliptical motion and to move the driven body by the elliptical motion.

5. The robot control method according to claim 4, wherein
the drive mode includes a plurality of first drive modes in which a separation amplitude, which is an amplitude of the longitudinal vibration, is increased while a feed amplitude, which is an amplitude of the bending vibration, is constant and
a plurality of different feed amplitudes are set in the plurality of first drive modes.

6. The robot control method according to claim 5, wherein
in the first drive mode, the bending vibration is excited and then the longitudinal vibration is excited.

7. The robot control method according to claim 4, wherein
the drive mode includes
a first drive mode in which a separation amplitude, which is an amplitude of the longitudinal vibration, is increased while a feed amplitude, which is an amplitude of the bending vibration, is constant and
a second drive mode in which both of the feed amplitude and the separation amplitude are increased.

8. A robot comprising:
a first member;
a second member connected to the first member;
a drive device configured to rotate or slide the second member with respect to the first member;
an end effector connected to the second member; and
a control device that controls drive of the drive device, wherein
the control device detects, based on an output signal from an inertial sensor disposed on the end effector, a gravity influence amount indicating a degree of influence of gravity received by the end effector,
determines, based on the detected gravity influence amount, a drive algorithm for the drive device from among a plurality of drive modes, and
drives the drive device by the determined drive algorithm.
